(19) United States
(12) Patent Application Publication
(10) Pub. No.: US 2002/0117376 A1
(43) Pub. Date: Aug. 29, 2002

(54) Essential oil evaporator

(76) Inventor: Jer-Ming Cheng, Taipei (TW)

Correspondence Address: Jer-Ming Cheng, P.O. Box No. 6-57, Taipei Hsien 235, Chung-Ho City, TW

(21) Appl. No.: 09/791,599

(22) Filed: Feb. 26, 2001

(51) Int. Cl. B01D 1/00

(52) U.S. Cl. 196/132; 196/155; 159/44

(57) ABSTRACT

An essential oil evaporator has timing control by a controller for audio and visual effect. The controller controls a loud speaker and an LED lamp in a progressive and synchronous way. Moreover, the controller also activates a heater through a trigger unit. Therefore, the user can aware the turn on and turn off of the heater with the help of audio and visual effect.

### BACKGROUND OF THE INVENTION

1. Field of the Invention

The present invention relates to an essential oil evaporator with timing control for audio and visual effect, especially to an essential oil evaporator controlled by a controller in a progressive way to provide audio and visual effect.

2. Description of the Prior Art

The essential oil is often used to provide anodyne effect for people because the odor exhaled from the essential oil can calm the spirit of people. Therefore, the evaporator for evaporating the essential oil is also developed.

The prior art essential oil evaporator employs a candle to heat essential oil contained in an oil bowl. The odor molecule evaporated from the essential oil distributes into air and spreads through Brownian motion. However, the use of the candle is not safe and the duration for evaporating the essential oil is hard to control. Moreover, the essential oil can also be evaporated in a thermo-electric way. A thermoelectric resistor is used to heat the essential oil. However, the use of thermoelectric resistor cannot provide steady temperature and may generate overheat to the essential oil. As a result, the molecular structure of the essential oil is deconstructed. The use of thermo-electric resistor also has the risk of spark.

### SUMMARY OF THE INVENTION

It is an object of the present invention to provide an essential oil evaporator to provide steady-thermal control to the oil.

It is another object of the present invention to provide an essential oil evaporator controlled by a controller in a progressive way to provide audio and visual effect.

To achieve above objects, the essential oil evaporator according to the present invention has a controller controlling a loud speaker and an LED lamp in a progressive and synchronous way. Moreover, the controller also activates a heater composed of ceramic resistor with positive thermal coefficient. The ceramic resistor with positive thermal coefficient provide steady heating and is not flammable. Therefore, the user can aware the turn on and turn off of the heater with the help of audio and visual effect.

The various objects and advantages of the present invention will be more readily understood from the following detailed description when read in conjunction with the appended drawing, in which:

### BRIEF DESCRIPTION OF THE DRAWINGS

FIG. 1 is the perspective view of the present invention;

FIG. 2 is the sectional view of the f present invention;

FIG. 3 shows the outlook of the present invention; and

FIG. 4 shows the building block of the essential oil evaporator according to the present invention.

### DETAILED DESCRIPTION OF THE PREFERRED EMBODIMENTS

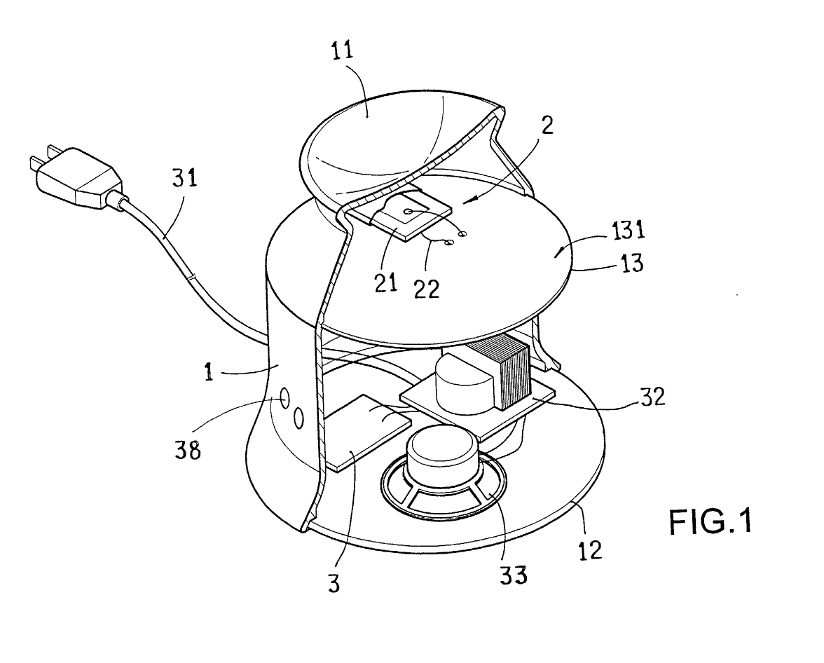

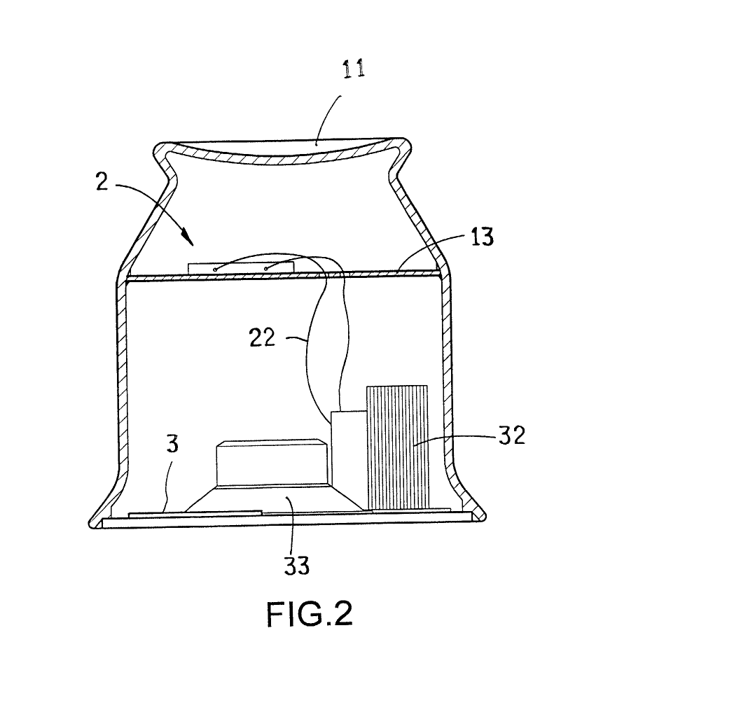

With reference now to FIG. 1 and 2, the present invention is intended to provide an essential oil evaporator with timing control for audio and visual effect. As shown in those figures, the essential oil evaporator according to the present invention comprises a ceramic case 1 housing a heat-insulating plate 13 therein. A thermal reflecting layer 131 for reflecting the thermal radiation is provided on top of the heat-insulating plate 13. An oil bowl 11 is arranged atop the ceramic case 1. A heater 2 is provided within the case 1 and below the oil bowl 11, the heater 2 comprises ceramic resistor 21 with positive thermal coefficient and connected to a power source (such as a rectifying transformer 32) through wires 22. The case 1 has a base plate 12 on bottom thereof, and a controller 3, a rectifying transformer 32 and a loud speaker 33 are arranged on the base plate 12. At least one LED lamp 38 is arranged on the case 1. The loud speaker 33 and the LED lamp 38 are controller by the controller 3 and powered through the power cord 31.

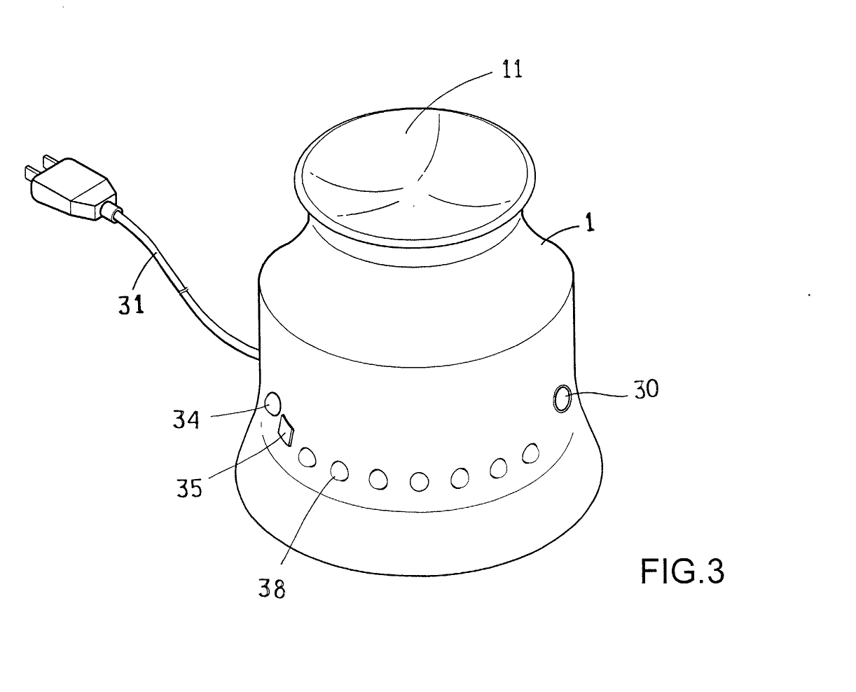

With reference now to FIG. 3, the oil bowl 11 is of concave shape and used to store essential oil. A switch 30 is arranged on the case 1 and connected to the power cord 3 1. When the switch 30 is activated, the loud speaker 33 and the LED lamp 38 are controller by the controller 3 to provide audio and visual effect, and the heater 2 is activated to heat the oil.

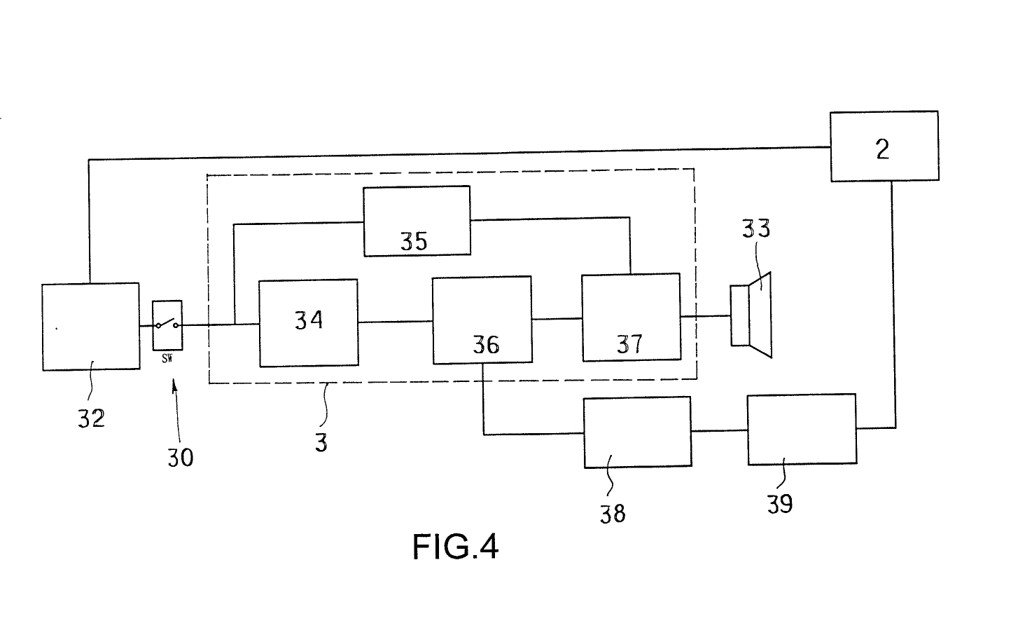

FIG. 4 shows the building block of the essential oil evaporator according to the present invention. The controller 3 is powered by the rectifying transformer 32 through the switch 30. The rectifying transformer 32 is also connected to the heater 2 to provide power to the heater 2. The controller 3 comprises a music selection switch 34 and a time setting switch 35. When the switch 30 is turned on, the music selection switch 34 is operated to select one music program from the music IC 36 and the music program is played to the loud speaker 33 through an audio amplifier 37. Moreover, the music IC 36 also triggers the LED lamp 38 to provide visual effect. The music IC 36 has progressive control such that the loud speaker 33 and the LED lamp 38 are faded in initially and faded out when the set time is over. Moreover, the heater 2 is simultaneously turned off with the loud speaker 33 and the LED lamp 38 by the controller 3. The LED lamp 38 is also connected to a trigger means 39 to trigger the heater 2 for synchronous operation.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. An essential oil evaporator with timing control for audio and visual effect, comprising:
a ceramic case housing a heat-insulating plate therein;
an oil bowl arranged atop the ceramic case;
a heater below the oil bowl and atop the heat-insulating plate, and made of ceramic resistor with positive thermal coefficient;
a controller within the case and comprising a music selection switch, a time setting switch and a music IC for storing music program;
a loud speaker housed in the case and at least one LED lamp on the case;
the LED lamp connected to the heater through a trigger unit;
the controller controlling the loud speaker and the LED lamp in a progressive and synchronous way; the controller also activating the heater through the trigger unit.
